(19) United States
(12) Patent Application Publication
(10) Pub. No.: US 2007/0110535 A1
(43) Pub. Date: May 17, 2007

(54) Structure of a trailer bed

(76) Inventor: Chun-I Chang, Taichung City (TW)

Correspondence Address: LEONG C LEI, PMB # 1008, 1867 YGNACIO VALLEY ROAD, WALNUT CREEK, CA, 94598, US

(21) Appl. No.: 11/280,207

(22) Filed: Nov. 17, 2005

(51) Int. Cl. B60P 3/08

(52) U.S. Cl. 410/24

(57) ABSTRACT

A structure of a trailer bed having a lower level trailer bed and an upper level trailer rack, wherein two sides of the lower level trailer bed utilize parallel pillars as support, the top end of the pillar is mounted with a substantially horizontal upper level trailer rack, the end of the lower level trailer bed is mounted with an elevating/retracting plate allowing a carrier car to going in and out, the upper level trailer rack is pivotally mounted with an elevating/retracting trailer bed module, and the height of the trailer bed is adjustable for ferrying various type of vehicles onto the trailer bed so as to provide safety in the course of transporting.

### BACKGROUND OF THE INVENTION

(a) Technical Field of the Invention

The present invention relates to a trailer bed, and in particular, the height of the trailer bed being adjustable for ferrying various type of vehicles onto the trailer bed so as to provide safety in the course of transporting.

(b) Description of the Prior Art

Generally new vehicles such as saloon cars, prior to being legally allowed to drive on a road, are loaded onto a trailer bed for transporting to either a show room or a designated site. Due to the fact that there are various car types and car shapes, a trailer bed may only be suitable for use in transporting a certain size car. As for the type of car, a different trailer bed may have to be designed. However, in order to save cost in ferrying these cars, it is very often that a trailer bed, which is only suitable for use carrying smaller cars, may be used to ferry larger size cars. Accordingly, this is unsafe and the number of cars to be transported is very limited.

Accordingly, it is an object of the present invention to provide an improved structure of a trailer bed which allows more cars to be transported and the trailer bed can be used to transport cars of different sizes.

### SUMMARY OF THE INVENTION

The primary purpose of the present invention is to provide an improved structure of a trailer bed having a lower level trailer bed and an upper level trailer rack. The two sides of the lower level trailer bed utilizes parallel pillars as support, the top end of the pillar is mounted with the substantially horizontal upper level trailer rack, and the end of the lower level trailer bed is mounted with an elevating/retracting plate allowing a carrier car to go in and out. The upper level trailer rack is pivotally mounted with an elevating/retracting trailer bed module; the lower level trailer plate is provided with a relatively higher front section trailer plate, and the middle section of the lower level trailer plate adjacent to the front section trailer plate is pivotally provided with a sloping passage, and the two sides of the front end of the sloping passage corresponding to the pillars being a retractable shaft module, and the front section of the sloping passage corresponding to the retractable shaft module is a securing valve module; the front section of the upper level trailer rack is protruded with an upper level front rack corresponding to the front section trailer plate of the lower level trailer plate and the upper level trailer rack and the upper level front rack respectively mounted with an elevating/retracting trailer plate module and a front elevating/retracting trailer plate, wherein the two ends of the front elevating/retracting trailer plate respectively utilize the corresponding pillars mounted to the first and second elevating/retracting module; and the elevating/retracting trailer plate includes the first elevating/retracting trailer plate and the second elevating/retracting trailer plate, and the first elevating/retracting trailer plate is mounted at the upper level trailer rack adjacent to the front section of the upper level front rack, and the two end of the first elevating/retracting trailer plate respectively utilizes the pillars mounted to the two sides of the third and forth elevating/retracting module, and the second elevating/retracting trailer plate is provided at the rear section of the upper level trailer rack, and the two ends of the second elevating/retracting trailer plate utilizes the pillar mounted to the two sides of the fifth and sixth elevating/retracting module, and the end of the second elevating/retracting trailer plate is inclined downward to urge the top face of the lower level trailer plate to allow transported cars to enter in or out of the upper level trailer rack.

Still a further object of the present invention is to provide an improved structure of a trailer bed, wherein the first elevating/retracting module corresponding to one side of the pillar is an extractable shaft having both ends thereof mounted between the front section trailer plate and the front elevating/retracting trailer plate, and one side of the retractable shaft is perpendicularly mounted with a guiding shaft having a plurality of positioning holes, and the top end of the retractable shaft is mounted with a securing valve on the guiding shaft by means of a sliding mount and the second elevating/retracting module is provided with a first retractable shaft between the front section trailer plate and another end of the front elevating/retracting trailer plate, and the inner face of the pillar is a guiding rail having corresponding holes for the insertion positioning of an insertion rod so that the front elevating/retracting trailer plate uses the first and second elevating/retracting module to proceed with corresponding up and down sliding movement of the upper level.

Yet still another object of the present invention is to provide an improved structure of a trailer bed, wherein the third elevating/retracting module is provided with a horizontal shaft between the two sides of the pillar, and the first elevating/retracting trailer plate is pivotally mounted to the horizontal shaft and the two sides of the pillar is an extendable shaft urging the horizontal shaft, and the bottom face of the horizontal shaft is a guiding shaft parallel to the extendable shaft and the guiding shaft is provided with a plurality of equidistant holes, and the middle section of the extendable shaft is a securing valve having a sliding mount, and the guiding shaft is mounted to the sliding mount, and the forth elevating/retracting module pivotally mounts the bottom end of the extendable shaft to the lower level trailer plate, and the other end of the extendable shaft is positioned to the middle section of the two sides of the elevating/retracting trailer plate, and one side of the extendable shaft is mounted in parallel to a guiding shaft with corresponding positioning holes, and the positioning holes are of equal height with that of the guiding shaft of the third elevating/retracting module, and the top end of the extendable shaft is provided with a securing valve using the sliding mount to mount onto the guiding shaft, and the first elevating/retracting trailer plate uses the third, and the forth elevating/retracting module to pivotally rotate or incline in accordance with the upper level trailer rack.

A further object of the present invention is to provide an improved structure of a trailer bed, wherein the fifth elevating/retracting module has a horizontal shaft positioned between the pillars, and the second elevating/retracting trailer plate is correspondingly and pivotally mounted to the horizontal shaft, and the two sides of the pillar is provided with an extendable shaft having an urging horizontal shaft and the bottom face of the horizontal shaft is a guiding shaft parallel to the extendable shaft, and the guiding shaft is provided with a plurality of equidistant positioning holes, and the middle section of the extendable shaft is a securing valve having a sliding mount, and the sixth elevating/retracting module pivotally mounts the bottom end of the first extendable shaft to the lower level trailer plate, and the other end of the extendable shaft is inclined at the middle section of the side of the section elevating/retracting trailer plate, and the pillar corresponding to the rear section of the two sides of the second elevating/retracting trailer plate is a guiding rail having corresponding positioning holes, and the positioning holes are of same height with that of the guiding shaft of the fifth elevating/retracting module, and the second elevating/retracting trailer plate corresponding to the guiding rail is a positioning valve such that the second elevating/retracting trailer plate utilizes the fifth and sixth elevating/retracting module to incline or pivotally move in accordance with the upper level trailer rack.

Yet a further object of the present invention is to provide an improved structure of a trailer bed, wherein the top end of the extendable shaft of the sixth elevating/retracting module at the two sides of the second elevating/retracting trailer plate is provided with a guiding plate, and the two guiding plates are respectively mounted to the sliding slot shaft, and the two sliding slot shafts are perpendicularly mounted between the lower trailer plate and the upper level trailer rack so as to keep stable.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of an improved structure of a trailer bed of the present invention.

FIG. 2 is a schematic view showing the actual application of the improved structure of a trailer bed of the present invention.

FIG. 3 is a perspective view showing the sloping path of the improved structure of a trailer bed of the present invention.

FIG. 4 is a perspective view showing the front elevating bed module of the present invention.

FIG. 5 is a perspective view showing the lowering bed module of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

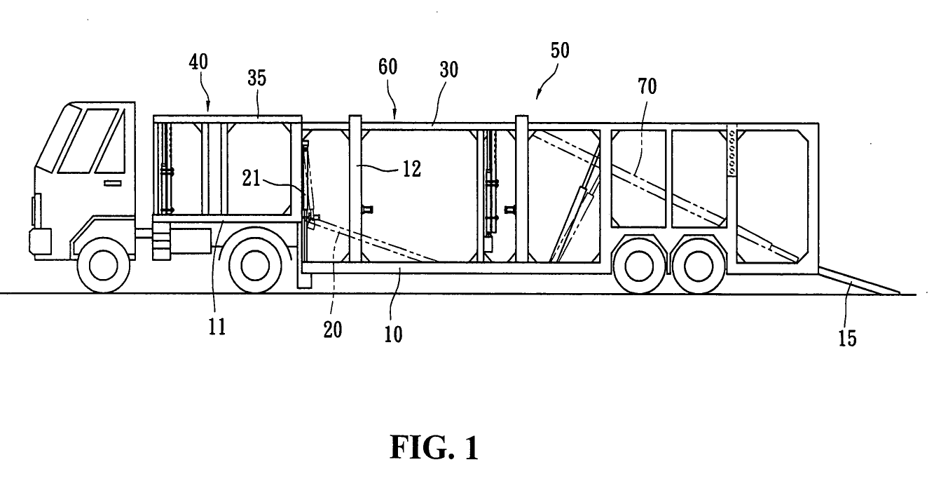

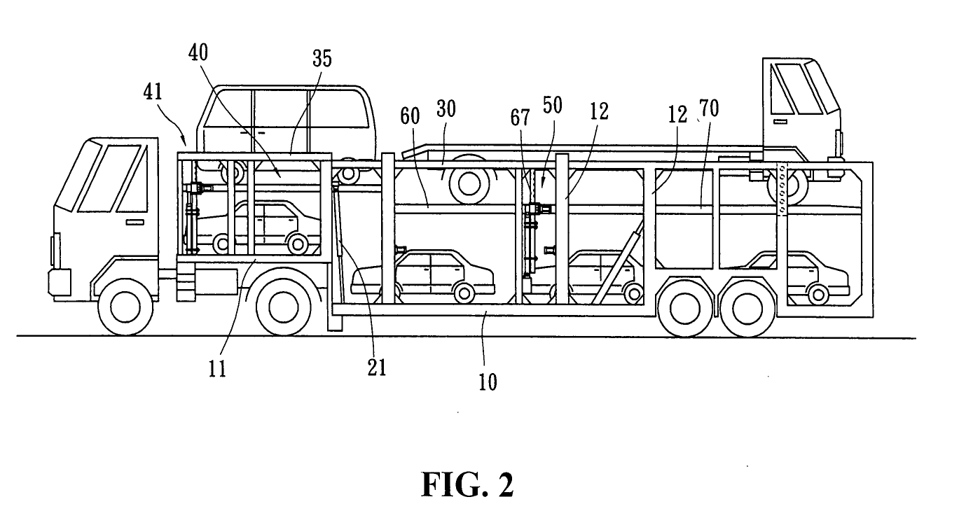

Referring to FIGS. 1 and 2, there is shown an improved structure of a trailer bed having a lower level trailer plate 10 with an upright pillar at the sides thereof as support. The top end of the individual pillar 12 is provided with a substantially horizontal upper level trailer rack 30. The end terminal of the lower level trailer plate is a retractable trailer plate 15 which allows vehicles for transporting to go up and down from the trailer. The upper level trailer rack 30 is pivotally mounted with an elevating/lowering trailer plate module 50 which can urge the top face of the lower level trailer plate 10. This structure will facilitate the entering and existing of vehicle.

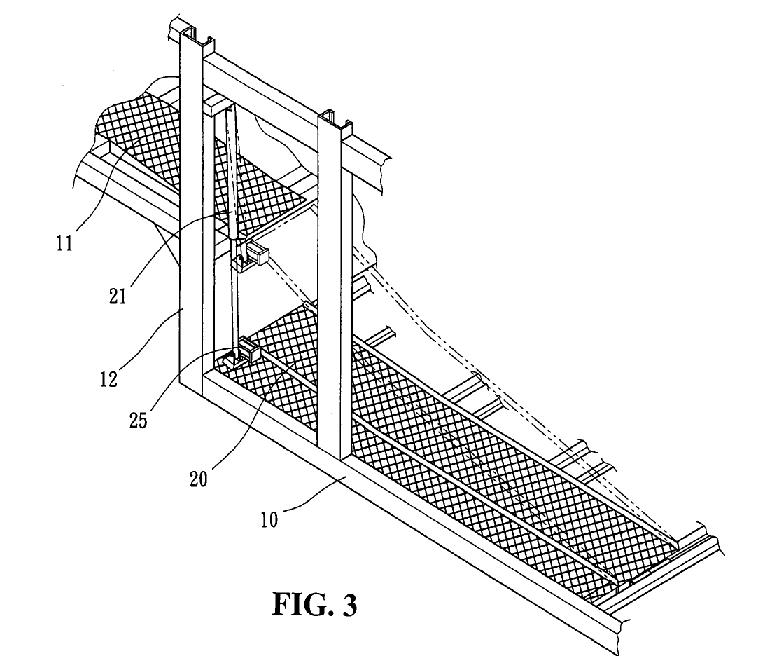

As shown in FIGS. 1, 2 and 3, the lower level trailer plate 10, corresponding to one end of the trailer, is a higher front section trailer plate 11 so as to avoid the front wheel of the trailer and to increase the capacity of the trailer. The middle section of the lower level trailer plate 10, adjacent to the front section trailer plate 11, is pivotally mounted with a sloping passage 20. A retractable shaft module 21 is provided between the two sides of the front end of the sloping passage 20 and the corresponding pillar 12 so that the retractable shaft module 21 provides the elevation and lowering (as shown in FIG. 3) of the sloping passage 20. The front section of the sloping passage 20 corresponding to the retractable shaft module 21 is provided with a securing valve module 25 at the pivotal position. The securing valve module 25 is for the engagement of the end face of the front section trailer plate 11 with the lower level trailer plate 10. Thus, the securing of the sloping passage 20 is stable and the sloping passage 20 will not be dislocated and vehicles could enter into and exist from the front section trailer plate 11.

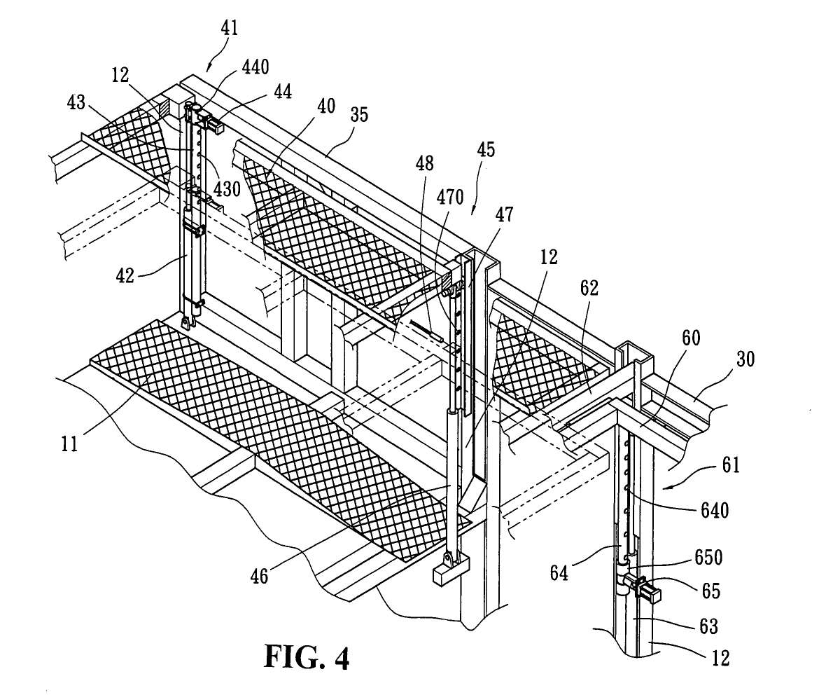

Referring to FIGS. 1, 4 and 5, the front section of the upper level trailer rack 30 is an upper level front rack 35 corresponding to the front section trailer plate 11 of the lower level trailer plate 10. On the upper level trailer rack 30 and the upper level front rack 35, an elevating/lowering trailer plate module 50 and a front elevating/lowering trailer plate 40 are provided. The two ends of the front elevating/lowering trailer plate 40 are provided with two pillars by means of the first and the second elevating/lowering module 41, 45. The first elevating/lowering module corresponding to one side of the pillar 12, is a retractable shaft 42. The two ends of the retractable shaft 42 are respectively mounted between the front section trailer plate 11 and the front elevating/lowering trailer plate 40, and one side of the retractable shaft 42 is mounted with a parallel guiding shaft 43. The upper section of the guiding shaft 43 is provided with equal spaced positioning holes 430. The top end of the retractable shaft 42 has a securing valve 44 which is provided on the guiding shaft by means of the sliding mount 440. The securing valve 44 is corresponding to the positioning hole 430 to provide a positioning function. Between the front section trailer plate 11 and the front elevating/lowering trailer plate 40, an extractable shaft 46 is provided and the inner face of the corresponding pillar, a guiding rail 47 is provided. One side of the guiding rail 47 is provided with equal distance positioning holes 470, and the positioning hole 470 has the same height and distance from the positioning hole 430 allowing an insertion rod 48 to be inserted and secured and the front elevating/lowering trailer plate 40 makes use of the first and second elevating/lowering module 41, 45 to correspond to the movement of the upper level front rack 35.

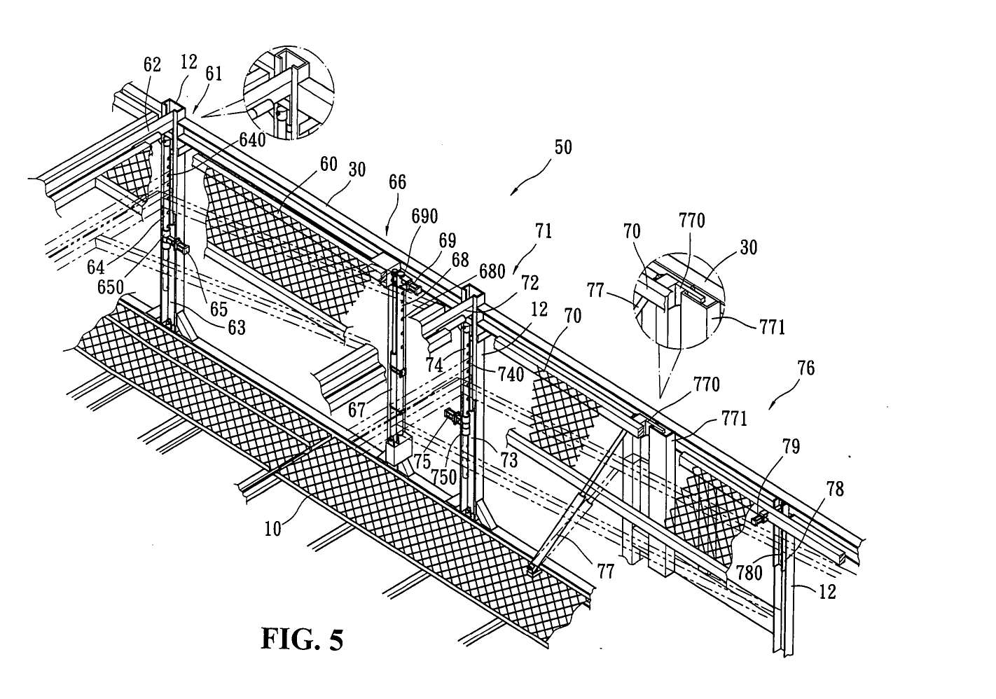

As shown in FIG. 5, the elevating/lowering trailer module 50 includes a first elevating/lowering trailer plate 60 and a second elevating/lowering trailer plate 70. The first elevating/lowering trailer plate 60 is at the upper level trailer rack 30, adjacent to the front section of the upper level front rack 35. The two end of the first elevating/lowering trailer plate 60 employs the third and forth elevating/lowering module 61, 66 to mount onto the pillar 12 on a slide. The third elevating/lowering module 61 is at the sides of the pillar 12 which has a horizontal shaft 62 across. The corresponding end of the first elevating/lowering trailer plate 60 is pivotally mounted to the horizontal shaft 62 and the first elevating/lowering trailer plate 60 is inclined downward so as to shorten the length of the loading vehicles onto the trailer. The two sides of the pillar 12 is a retractable shaft 63 having two ends mounted between the lower level trailer plate and the horizontal shaft 62, and the bottom face of the horizontal shaft 62 is a guiding shat 64 parallel to the retractable shaft 63. The guiding shaft 64 has a plurality of positioning holes 640 which are of equal distance from each other. The middle section of the retractable shaft 63 is a securing valve 65 provided with a sliding mount 650 and the guiding shaft 64 is mounted at the sliding mount 650. A positioning hole 640 on the guiding shaft 64 provides positioning purpose. At the forth elevating/lowering module 66, the bottom end of the retractable shaft 67 is provided onto the lower level trailer plate 10. The other end is at the two sides of the middle section and one side of the retractable shaft 67 is a guiding shaft 68 in parallel. The upper section of the guiding shaft 68 has equal distance positioning holes 680. The positioning hole 680 and the positioning hole 640 of the guiding shaft 64 are equal distance and of same height. The top end of the retractable shaft 67 makes use of the sliding mount 690 to mount onto the securing valve 69 so that the securing valve 69 is corresponding to the positioning hole 680. The first elevating/lowering trailer plate 60 makes use of the third and forth elevating/lowering module 61, 66 to correspond to the up and down sliding movement or inclination of the upper level trailer rack 30.

The second trailer plate 70 is mounted to the rear section of the upper level trailer rack 30 and the two ends of the elevating/lowering trailer plate 70 are provided with two pillars 12 by means of the fifth and the sixth elevating/lowering module 71, 76. The fifth elevating/lowering module 71 has a horizontal shaft 72 across the two pillars 12, and the corresponding end section of the second elevating/lowering trailer plate 70 is pivotally mounted with a horizontal shaft 72, so that the other end of the second elevating/lowering trailer plate 70 can be downwardly inclined to urge the lower level trailer plate 10 to allow the vehicles to enter and exist the upper level trailer rack 30. In between the sides of the pillars 12, there is a retractable shaft 73 having two ends mounted to the lower level trailer plate 10 and the horizontal shaft 72, and the bottom face of the horizontal shaft 72 is provided with a guiding shaft 74 which is parallel to the retractable shaft 73. There is a plurality of positioning holes 740 on the guiding shaft 74. The middle section of the retractable shaft 73 is a securing valve 75 having a sliding mount 750. The guiding shaft 74 is mounted to the sliding mount 750, and the securing valve 75 is used to mount on the guiding shaft 74 at the positioning hole 740. The sixth elevating/lowering module 76 mounts the bottom end of the second elevating/lowering shaft 77 to the lower level trailer plate 10, and the other end is inclined at the middle section of the second elevating/lowering trailer plate 70. The top end of the retractable shaft 77 at the two sides of the second elevating/lowering trailer plate 70 is protruded with a guiding plate 770, and the two guiding plates 770 are respectively mounted within the sliding shaft 771. The sliding shafts 771 are perpendicularly mounted between the lower level trailer plate 10 and the upper level trailer rack 30 so as to provide balancing. The pillars 12 are provided with a guiding rail 78 and the wall of the guiding rail 78 has a plurality of positioning holes 780. The positioning holes 780 and the positioning hole 740 are of same height. The second elevating/lowering trailer plate 70 corresponding to the guiding rail 78 has a securing valve 79 to provide securing at the positioning hole 780 so that the elevating/lowering trailer plate 70 make use of the fifth and sixth elevating/lowering module to move in accordance with the up down movement of the upper level trailer rack 30 and the sixth elevating/lowering module 76 is used for the inclination of the second elevating/lowering trailer plate 70.

As shown in FIGS. 1 and 2, when vehicles are to be transported. The elevating and lowering trailer plate 15 is lowered, and the securing valve 79 of the sixth elevating/lowering module 76 is retracted, so that the rear end of the second elevating/lowering trailer plate 70 is separated from the upper level trailer rack 30, and the retractable shaft 77 is retracted. The second elevating/lowering trailer plate 70 is inclined to the horizontal shaft 72, and the guiding plate 770 at the top end of the retractable shaft 77 slides within the sliding shaft 771 so as to keep balance, and the end of the second elevating/lowering trailer plate 70 to urge the trop face of the lower level trailer plate 10 to allow vehicle to move upward to the front elevating/lowering trailer plate 40 and the second and first elevating/lowering trailer plates 60, 70. The retractable shaft 77 of the second elevating/lowering trailer plate 70 is protruded so that the second elevating/lowering trailer plate maintains horizontal, and the securing valve 79 causes the second elevating/lowering trailer plate 70 to be mounted to the guiding rail 78. Thus, the vehicles are loaded onto the upper level trailer rack 30.

The sloping passage 20 is upward inclined by means of the retractable shaft module 21 and the securing valve 25 is used to locked the movement to allow vehicles to enter the front section trailer plate 11 of the lower level trailer plate 10. Next the sloping passage 20 is lowered and other vehicles can enter at the lower level trailer pate 10, and the lowering and elevating trailer plate 15 is retracted.

When the height of the vehicles to be transported at the upper level trailer rack 30 is high, then the first and the second elevating/lowering module 41, 45, the third and the forth elevating/lowering module 61, 66 and the sixth and the fifth elevating/lowering module 71, 76 are retracted at the same height so that the front elevating/lowering trailer plate 40, the first elevating/lowering trailer plate 60 or the second elevating/lowering trailer plate 70 can be retracted horizontally so that the center of gravity of the transported vehicle is lowered.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a trailer bed having a lower level trailer bed and an upper level trailer rack, the two sides of the lower level trailer bed utilized parallel pillars as support and the top end of the pillar being mounted with the substantially horizontal upper level trailer rack and the end of the lower level trailer bed mounted with an elevating/retracting plate allowing a carrier car to going in and out, the upper level trailer rack being pivotally mounted with an elevating/retracting trailer bed module;
the lower level trailer plate is provided with a relatively higher front section trailer plate, and the middle section of the lower level trailer plate adjacent to the front section trailer plate being pivotally provided with a sloping passage, and the two sides of the front end of the sloping passage corresponding to the pillars being a retractable shaft module, and the front section of the sloping passage corresponding to the retractable shaft module being a securing valve module;
the front section of the upper level trailer rack being protruded with an upper level front rack corresponding to the front section trailer plate of the lower level trailer plate and the upper level trailer rack and the upper level front rack respectively mounted with an elevating/retracting trailer plate module and a front elevating/retracting trailer plate, wherein the two ends of the front elevating/retracting trailer plate respectively utilize the corresponding pillars mounted to the first and second elevating/retracting module; and the elevating/retracting trailer plate includes the first elevating/retracting trailer plate and the second elevating/retracting trailer plate, and the first elevating/retracting trailer plate is mounted at the upper level trailer rack adjacent to the front section of the upper level front rack, and the two end of the first elevating/retracting trailer plate are respectively utilize the pillars mounted to the two sides of the third and forth elevating/retracting module, and the second elevating/retracting trailer plate is provided at the rear section of the upper level trailer rack, and the two ends of the second elevating/retracting trailer plate utilize the pillar mounted to the two sides of the fifth and sixth elevating/retracting module, and the end of the second elevating/retracting trailer plate is inclined downward to urge the top face of the lower level trailer plate to allow transported cars to enter in or out of the upper level trailer rack.

2. The improved structure of a trailer bed of claim 1, wherein the first elevating/retracting module corresponding to one side of the pillar is an extractable shaft having both ends thereof being mounted between the front section trailer plate and the front elevating/retracting trailer plate, and one side of the retractable shaft is perpendicular mounted with a guiding shaft having a plurality of positioning holes, and the top end of the retractable shaft is mounted with a securing valve on the guiding shaft by means of a sliding mount and the second elevating/retracting module is provided with a first retractable shaft between the front section trailer plate and another end of the front elevating/retracting trailer plate, and the inner face of the pillar is a guiding rail having corresponding holes for the insertion positioning of an insertion rod so that the front elevating/retracting trailer plate uses the first and second elevating/retracting module to proceed with corresponding up and down sliding movement of the upper level.

3. The improved structure of a trailer bed of claim 1, wherein the third elevating/retracting module is provided with a horizontal shaft between the two sides of the pillar, and the first elevating/retracting trailer plate is pivotally mounted to the horizontal shaft and the two sides of the pillar is an extendable shaft urging the horizontal shaft, and the bottom face of the horizontal shaft is a guiding shaft parallel to the extendable shaft and the guiding shaft is provided with a plurality of equidistant holes, and the middle section of the extendable shaft is a securing valve having a sliding mount, and the guiding shaft is mounted to the sliding mount, and the forth elevating/retracting module pivotally mounts the bottom end of the extendable shaft to the lower level trailer plate, and the other end of the extendable shaft is positioned to the middle section of the two sides of the elevating/retracting trailer plate, and one side of the extendable shaft is mounted in parallel to a guiding shaft with corresponding positioning holes, and the positioning holes are of equal height with that of the guiding shaft of the third elevating/retracting module, and the top end of the extendable shaft is provided with a securing valve using the sliding mount to mount onto the guiding shaft, and the first elevating/retracting trailer plate uses the third, and the forth elevating/retracting module to pivotally rotate or incline in accordance with the upper level trailer rack.

4. The improved structure of a trailer bed of claim 1, wherein the fifth elevating/retracting module has a horizontal shaft positioned between the pillars, and the second elevating/retracting trailer plate is correspondingly and pivotally mounted to the horizontal shaft, and the two sides of the pillar is provided with an extendable shaft having an urging horizontal shaft and the bottom face of the horizontal shaft is a guiding shaft parallel to the extendable shaft, and the guiding shaft is provided with a plurality of equidistant positioning holes, and the middle section of the extendable shaft is a securing valve having a sliding mount, and the sixth elevating/retracting module pivotally mounts the bottom end of the first extendable shaft to the lower level trailer plate, and the other end of the extendable shaft is inclined at the middle section of the side of the section elevating/retracting trailer plate, and the pillar corresponding to the rear section of the two sides of the second elevating/retracting trailer plate is a guiding rail having corresponding positioning holes, and the positioning holes are of same height with that of the guiding shaft of the fifth elevating/retracting module, and the second elevating/retracting trailer plate corresponding to the guiding rail is a positioning valve such that the second elevating/retracting trailer plate utilises the fifth and sixth elevating/retracting module to incline or pivotally move in accordance with the upper level trailer rack.

5. The improved structure of a trailer bed of claim 1 or 4, wherein the top end of the extendable shaft of the sixth elevating/retracting module at the two sides of the second elevating/retracting trailer plate is provided with a guiding plate, and the two guiding plates are respectively mounted to the sliding slot shaft, and the two sliding slot shafts are perpendicularly mounted between the lower trailer plate and the upper level trailer rack so as to keep stable.
